(19) United States
(12) Patent Application Publication
(10) Pub. No.: US 2024/0075819 A1
(43) Pub. Date: Mar. 7, 2024

(54) STRUCTURAL CROSS-MEMBER ASSEMBLIES FOR TRACTION BATTERY PACKS

(71) Applicant: FORD GLOBAL TECHNOLOGIES, LLC, Dearborn, MI (US)

(72) Inventors: Mohammadreza EFTEKHARI, Novi, MI (US); Patrick Daniel MAGUIRE, Ann Arbor, MI (US); Alex REVELS, Canton, MI (US); Brock DUNLAP, Dearborn, MI (US)

(21) Appl. No.: 18/105,428

(22) Filed: Feb. 3, 2023

Related U.S. Application Data
(60) Provisional application No. 63/403,445, filed on Sep. 2, 2022.

(51) Int. Cl. B60L 50/64; H01M 50/204; H01M 50/291; H01M 50/367

(52) U.S. Cl. CPC B60L 50/64; H01M 50/204; H01M 50/291; H01M 50/367; H01M 2220/20

(57) ABSTRACT

Structural cross-member assemblies are provided for traction battery packs. An exemplary cross-member assembly may include a cross-member beam having a beam body and at least one reinforcement section that provides structural integrity to the beam body. The reinforcement section may be a pultrusion and may embody various cross-sectional shapes. The cross-member beam may be positioned adjacent to an additional cross-member beam to establish the cross-member assembly disposed between adjacent cell stacks of the traction battery pack.

### CROSS-REFERENCE TO RELATED APPLICATIONS

This disclosure claims priority to U.S. Provisional Application No. 63/403,445, which was filed on Sep. 2, 2022 and is incorporated herein by reference.

### TECHNICAL FIELD

This disclosure relates generally to traction battery packs, and more particularly to structural cross-member assemblies for use within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a cell stack including a plurality of battery cells arranged between a first cross-member beam and a second cross-member beam. Each of the first cross-member beam and the second cross-member beam includes at least one pultrusion.

In a further non-limiting embodiment of the foregoing traction battery pack, the first cross-member beam and the second cross-member beam establish a cross-member assembly that separates the cell stack from a second cell stack of the traction battery pack.

In a further non-limiting embodiment of either of the foregoing traction battery packs, a venting passageway is disposed between the first cross-member beam and the second cross-member beam.

In a further non-limiting embodiment of any of the foregoing traction battery packs, an enclosure cover provides a vertically upper side of the venting passageway, and an enclosure tray or a heat exchanger plate provides a vertically lower side of the venting passageway.

In a further non-limiting embodiment of any of the foregoing traction battery packs, each of the first cross-member beam and the second cross-member beam includes a C-shaped cross section or an I-shaped cross section.

In a further non-limiting embodiment of any of the foregoing traction battery packs, the at least one pultrusion includes an L-shaped or a T-shaped cross-section.

In a further non-limiting embodiment of any of the foregoing traction battery packs, the at least one pultrusion includes a zig-zagged shaped cross-section.

In a further non-limiting embodiment of any of the foregoing traction battery packs, each of the first cross-member beam and the second cross-member beam includes a beam body, a first reinforcement section that establishes a first pultrusion of the at least one pultrusion, and a second reinforcement section that establishes a second pultrusion of the at least one pultrusion.

In a further non-limiting embodiment of any of the foregoing traction battery packs, the first pultrusion is disposed within an upper portion of the beam body, and the second pultrusion is disposed within a lower portion of the beam body.

In a further non-limiting embodiment of any of the foregoing traction battery packs, the beam body includes a mid-portion that connects between the upper portion and the lower portion.

In a further non-limiting embodiment of any of the foregoing traction battery packs, the upper portion establishes an upper plateau, and the lower portion establishes a lower base.

In a further non-limiting embodiment of any of the foregoing traction battery packs, the first reinforcement section and the second reinforcement section are overmolded by the beam body.

In a further non-limiting embodiment of any of the foregoing traction battery packs, the at least one pultrusion includes an E-shaped cross-section.

A traction battery pack according to another exemplary aspect of the present disclosure includes, among other things, a first cell stack, a second cell stack, and a first cross-member beam arranged between the first cell stack and the second cell stack. The first cross-member beam includes a beam body, and a first reinforcement section and a second reinforcement section configured to structurally reinforce the beam body.

In a further non-limiting embodiment of the foregoing traction battery pack, the first cross-member beam is positioned adjacent to a second cross-member beam to establish a cross-member assembly that extends between the first cell stack and the second cell stack.

In a further non-limiting embodiment of either of the foregoing traction battery packs, the first reinforcement section and the second reinforcement section are pultrusions of the first cross-member beam.

In a further non-limiting embodiment of any of the foregoing traction battery packs, the first reinforcement section is disposed within an upper portion of the beam body, and the second reinforcement section is disposed within a lower portion of the beam body.

In a further non-limiting embodiment of any of the foregoing traction battery packs, the upper portion establishes an upper plateau of the first cross-member beam, and the lower portion establishes a lower base of the first cross-member beam.

In a further non-limiting embodiment of any of the foregoing traction battery packs, the first reinforcement section and the second reinforcement section are overmolded by the beam body.

In a further non-limiting embodiment of any of the foregoing traction battery packs, the first reinforcement section and the second reinforcement section each include an L-shaped cross section or an T-shaped cross section.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is a cross-sectional view through section 3-3 of FIG. 2.

FIG. 4 illustrates a cross-member beam of a cross-member assembly of the traction battery pack of FIGS. 2 and 3.

FIG. 5 illustrates a cross-sectional view of the cross-member beam of FIG. 4.

FIG. 6 illustrates a cross-sectional shape of an exemplary cross-member beam of a cross-member assembly.

FIG. 7 illustrates another cross-sectional shape of an exemplary cross-member beam of a cross-member assembly.

FIG. 8 illustrates a cross-sectional shape of a reinforcement section of a cross-member beam of a cross-member assembly.

FIG. 9 illustrates another cross-sectional shape of a reinforcement section of a cross-member beam of a cross-member assembly.

FIG. 10 illustrates yet another cross-sectional shape of a reinforcement section of a cross-member beam of a cross-member assembly.

### DETAILED DESCRIPTION

This disclosure details structural cross-member assemblies for traction battery packs. An exemplary cross-member assembly may include a cross-member beam having a beam body and at least one reinforcement section that provides structural integrity to the beam body. The reinforcement section may be a pultrusion and may embody various cross-sectional shapes. The cross-member beam may be positioned adjacent to an additional cross-member beam to establish a cross-member assembly disposed between adjacent cell stacks of the traction battery pack. These and other features are discussed in greater detail in the following paragraphs of this detailed description.

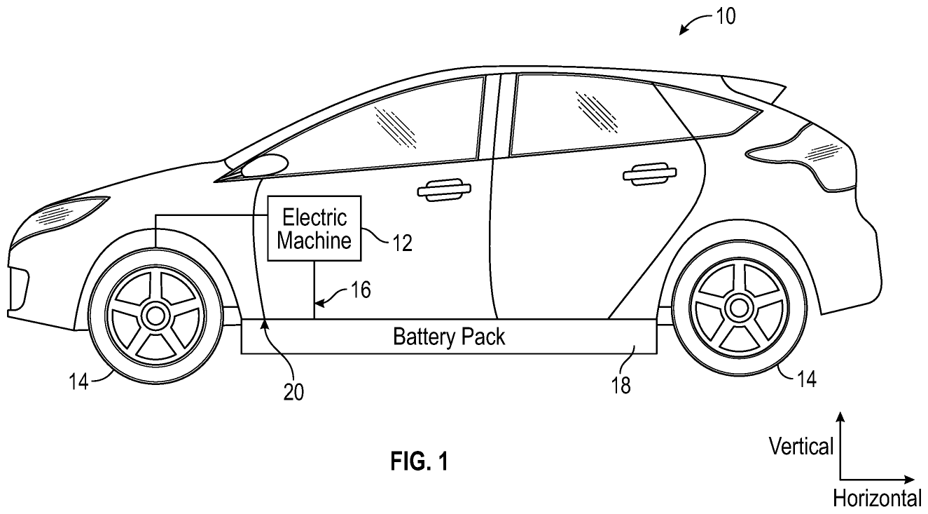

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

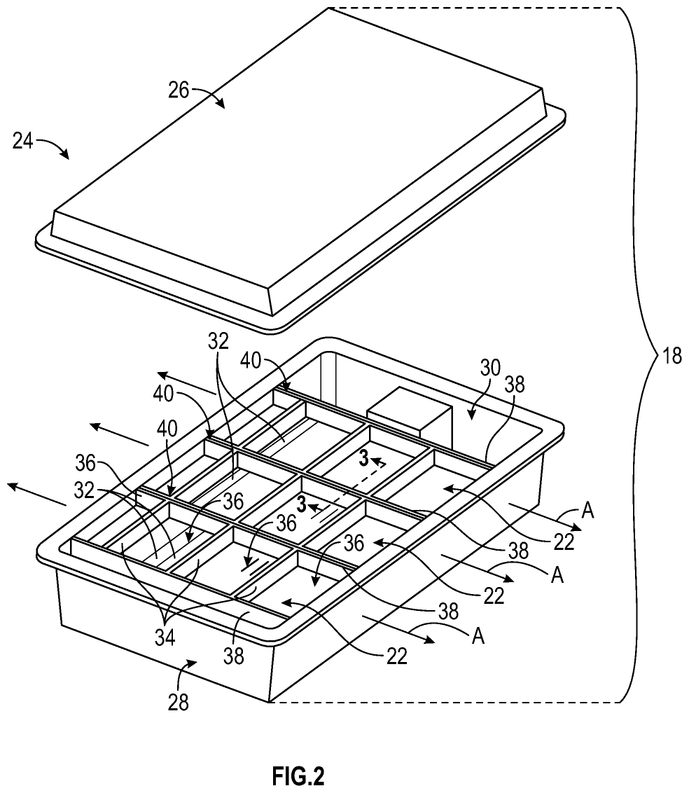

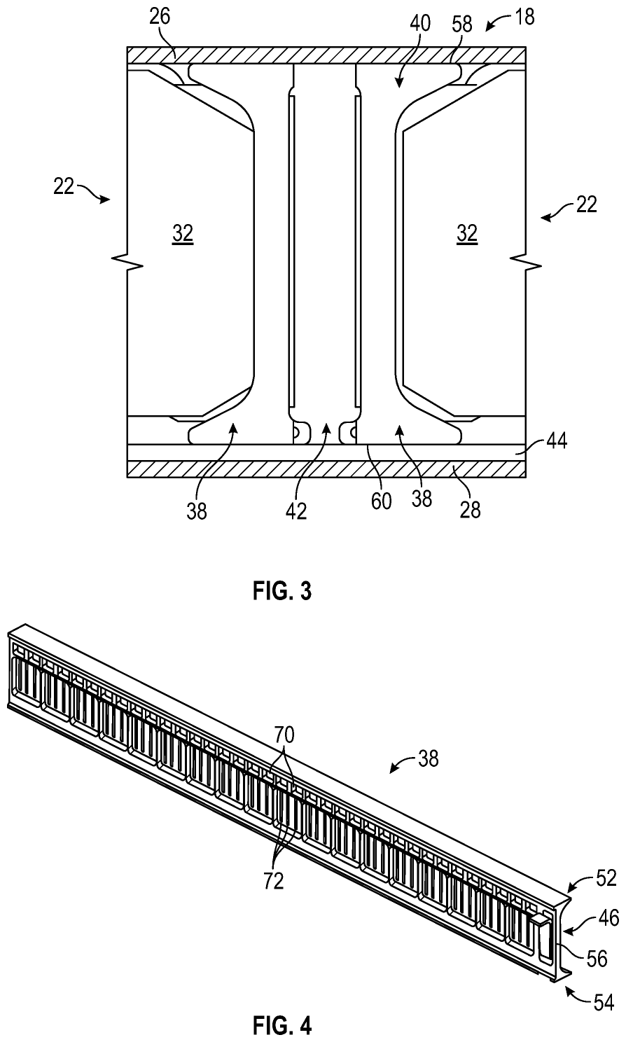

FIGS. 2 and 3 further illustrates details associated with the traction battery pack 18 of the electrified vehicle 10. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cells stacks 22 and other battery internal components.

Each cell stack 22 may include a plurality of battery cells 32. The battery cells 32 of each cell stack 22 may be stacked side-by-side relative to one another along a cell stack axis A. The battery cells 32 store and supply electrical power for powering various components of the electrified vehicle 10. Although a specific number of the cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The exemplary battery cells 32 can include tab terminals extending from a battery cell housing. An aluminum film may provide the battery cell housing, for example.

One or more dividers 34 may be arranged along the respective cell stack axis A of each cell stack 22. The dividers 34 may compartmentalize each cell stack 22 into two or more groupings or compartments 36 of battery cells 32. Each compartment 36 may hold one or more of the battery cells 32 within one of the cell stacks 22. In an embodiment, the battery cells 32 of each cell stack 22 are held within one of four compartments 36. However, other configurations, including configurations that utilize a greater or fewer number of compartments 36, could be used within the scope of this disclosure.

The battery cells 32 of each cells stack 22 may be arranged between a pair of cross-member beams 38. The cross-member beams 38 may be configured to hold the battery cells 32 and at least partially delineate the cell stacks 22.

Immediately adjacent-cross member beams 38 may established a cross-member assembly 40 disposed between adjacent cell stacks 22 of the traction battery pack 18. The cross-member assemblies 40 may be configured to transfer a load applied to a side of the electrified vehicle 10, for example. Each cross-member beam 38 of the cross-member assemblies 40 may be a structural beam that can help accommodate tension loads from battery cell 32 expansion and compression loads. The cross-member assemblies 40 are therefore configured to increase the structural integrity of the traction battery pack 18.

The cross-member assembles 40 may also establish a battery pack venting system for communicating battery cell vent byproducts from the traction battery pack 18 during battery thermal events. For example, the cross-member assemblies 40 may establish passageways 42 (best shown in FIG. 3) that communicate the battery cell vent byproducts from the cell stacks 22 toward a position where the battery cell vent byproducts can be expelled from the traction battery pack 18.

In the exemplary embodiment illustrated in FIG. 3, first and second adjacent cross-member beams 38 may establish a first side and a second side, respectively, of the passageway 42 of the cross-member assembly 40. Further, a vertically upper side of the passageway 42 may be established by the enclosure cover 26, and a vertically lower side of the passageway 42 may be established by a heat exchanger plate 44 positioned against the enclosure tray 28. In another embodiment, the heat exchanger plate 44 may be omitted and the vertically lower side of the passageway 42 may be established by the enclosure tray 28. Vertical and horizontal, for purposes of this disclosure, are with reference to ground and a general orientation of traction battery pack 18 when installed within the electrified vehicle 10 of FIG. 1.

Each cross-member beam 38 may include one or more openings 70 (see FIG. 4) for communicating the battery cell vent byproducts through the beams and into the passageway 42. The openings thus provide a path for battery cell vent byproducts to move to the passageways 42 as required. Each cross-member beam 38 may additionally include one or more openings 72 (see FIG. 4) for accommodating cell tabs of the battery cells 32.

The cross-member beams 38 may be adhesively secured to the enclosure cover 26 and to the heat exchanger plate 44. The adhesive can seal these interfaces to inhibit battery cell vent byproducts escaping the passageway 42 through these areas.

In an embodiment, the cells stacks 22, the cross-member assemblies 40, and the respective passageways 42 extend longitudinally in a cross-vehicle direction. However, other configurations are further contemplated within the scope of this disclosure.

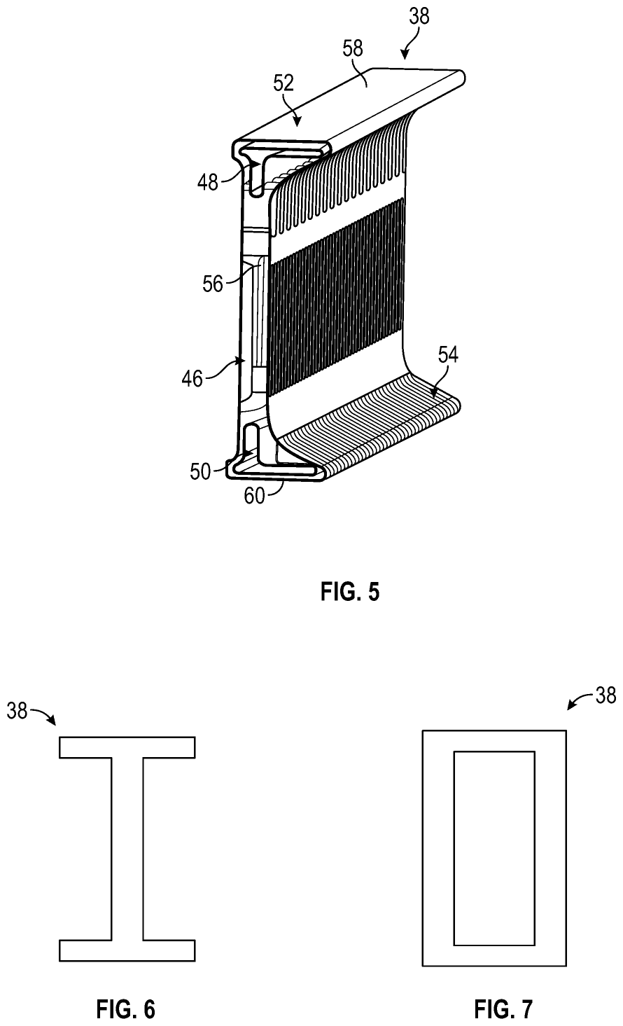

FIGS. 4 and 5 further illustrate details associated with one of the cross-member beams 38 of the traction battery pack 18. The additional cross-member beams of the traction battery pack 18 could include an identical design to the cross-member beam 38 shown in FIGS. 4-5.

In an embodiment, the cross-member beam 38 includes a general C-shaped cross-section (see, e.g., FIGS. 4-5). However, other cross-sectional shapes, such as I-shaped cross-sections (see FIG. 6), rectangular shaped cross-sections (see FIG. 7), etc., are also possible within the scope of this disclosure.

The cross-member beam 38 may include a beam body 46 and one or more reinforcement sections. In the illustrated embodiment, the cross-member beam 38 includes an upper or first reinforcement section 48 and a lower or second reinforcement section 50. However, other configurations are also contemplated within the scope of this disclosure.

The beam body 46 may be a unitary structure that includes an upper portion 52, a lower portion 54, and a mid-portion 56 extending between and connecting the upper portion 52 and the lower portion 54. The upper portion 52 may establish an upper plateau 58 of the cross-member beam 38, and the lower portion 54 may establish a lower base 60 of the cross-member beam 38. When positioned within the enclosure assembly 24 of the traction battery pack 18 in the manner shown in FIG. 3, the upper plateau 58 may interface with the enclosure cover 26, and the lower base 60 may interface with the heat exchanger plate 44 or the enclosure tray 28.

The beam body 46 may be made of any suitable thermoplastic material. In an embodiment, the beam body 46 is overmolded about each of the first reinforcement section 48 and the second reinforcement section 50. The first reinforcement section 48 may therefore extend inside the upper portion 52 of the beam body 46, and the second reinforcement section 50 may extend inside the lower portion 54 of the beam body 46. The first and second first reinforcement sections 48, 50 may therefore be positioned to structurally reinforce select portions (e.g., stress areas) of the beam body 46.

In an embodiment, the beam body 46, the first reinforcement section 48, and the second reinforcement section 50 each include substantially equivalent lengths. In other implementations, the length of the beam body 46 may be greater than the respective lengths of the first and second first reinforcement sections 48, 50.

In an embodiment, the first and second first reinforcement sections 48, 50 are pultrusions, which implicates structure to these beam-like sections. A person of ordinary skill in the art having the benefit of this disclosure would understand how to structurally distinguish a pultruded beam structure from another type of structure, such as an extruded beam, for example.

The first and second first reinforcement sections 48, 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the first and second first reinforcement sections 48, 50. The first and second first reinforcement sections 48, 50 may then be overmolded by the beam body 46 to provide a desired cross-section of the cross-member beam 38. The beam body 46 may be made of any suitable thermoplastic material.

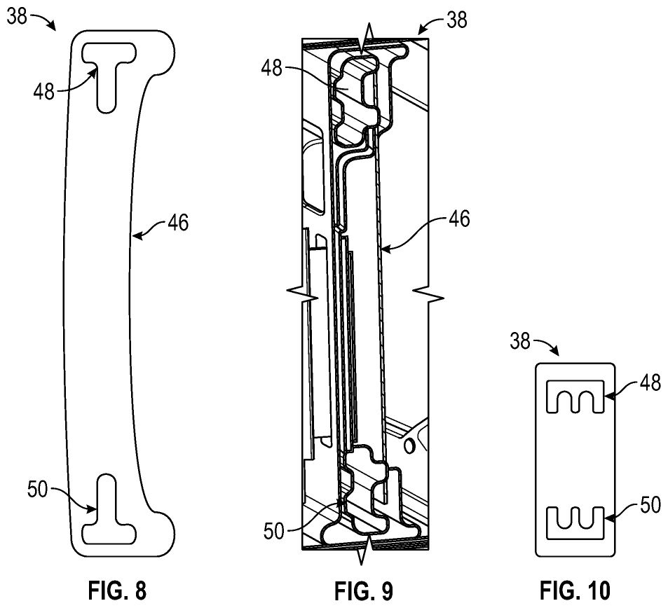

In an embodiment, the first and second first reinforcement sections 48, 50 each include an L-shaped cross-section (see FIG. 5). In another embodiment, the first and second first reinforcement sections 48, 50 each include a T-shaped cross-section (see FIG. 8). In yet another embodiment, the first and second first reinforcement sections 48, 50 may each include a zig-zagged shaped cross-section (see FIG. 9). In yet another embodiment, the first and second first reinforcement sections 48, 50 may each include an E-shaped cross-section (see FIG. 10). However, other cross-sectional shapes are contemplated within the scope of this disclosure.

The exemplary cross-member assemblies of this disclosure provide enhanced structural integrity over known battery cross-members. Incorporating reinforcement structures such as pultrusions increases strength and provides for the ability to manufacture more complex shapes, thereby permitting traction battery pack assembly to be achieved with less overall parts and less complexity.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a cell stack including a plurality of battery cells arranged between a first cross-member beam and a second cross-member beam; and
each of the first cross-member beam and the second cross-member beam includes at least one pultrusion.

2. The traction battery pack as recited in claim 1, wherein the first cross-member beam and the second cross-member beam establish a cross-member assembly that separates the cell stack from a second cell stack of the traction battery pack.

3. The traction battery pack as recited in claim 1, comprising a venting passageway disposed between the first cross-member beam and the second cross-member beam.

4. The traction battery pack as recited in claim 3, wherein an enclosure cover provides a vertically upper side of the venting passageway, and an enclosure tray or a heat exchanger plate provides a vertically lower side of the venting passageway.

5. The traction battery pack as recited in claim 1, wherein each of the first cross-member beam and the second cross-member beam includes a C-shaped cross section or an I-shaped cross section.

6. The traction battery pack as recited in claim 1, wherein the at least one pultrusion includes an L-shaped or a T-shaped cross-section.

7. The traction battery pack as recited in claim 1, wherein the at least one pultrusion includes a zig-zagged shaped cross-section.

8. The traction battery pack as recited in claim 1, wherein each of the first cross-member beam and the second cross-member beam includes a beam body, a first reinforcement section that establishes a first pultrusion of the at least one pultrusion, and a second reinforcement section that establishes a second pultrusion of the at least one pultrusion.

9. The traction battery pack as recited in claim 8, wherein the first pultrusion is disposed within an upper portion of the beam body, and the second pultrusion is disposed within a lower portion of the beam body.

10. The traction battery pack as recited in claim 9, wherein the beam body includes a mid-portion that connects between the upper portion and the lower portion.

11. The traction battery pack as recited in claim 9, wherein the upper portion establishes an upper plateau, and the lower portion establishes a lower base.

12. The traction battery pack as recited in claim 8, wherein the first reinforcement section and the second reinforcement section are overmolded by the beam body.

13. The traction battery pack as recited in claim 1, wherein the at least one pultrusion includes an E-shaped cross-section.

14. A traction battery pack, comprising:
a first cell stack;
a second cell stack; and
a first cross-member beam arranged between the first cell stack and the second cell stack,
wherein the first cross-member beam includes a beam body and a first reinforcement section and a second reinforcement section configured to structurally reinforce the beam body.

15. The traction battery pack as recited in claim 14, wherein the first cross-member beam is positioned adjacent to a second cross-member beam to establish a cross-member assembly that extends between the first cell stack and the second cell stack.

16. The traction battery pack as recited in claim 14, wherein the first reinforcement section and the second reinforcement section are pultrusions of the first cross-member beam.

17. The traction battery pack as recited in claim 14, wherein the first reinforcement section is disposed within an upper portion of the beam body, and the second reinforcement section is disposed within a lower portion of the beam body.

18. The traction battery pack as recited in claim 17, wherein the upper portion establishes an upper plateau of the first cross-member beam, and the lower portion establishes a lower base of the first cross-member beam.

19. The traction battery pack as recited in claim 14, wherein the first reinforcement section and the second reinforcement section are overmolded by the beam body.

20. The traction battery pack as recited in claim 15, wherein first reinforcement section and the second reinforcement section each include an L-shaped cross section or an T-shaped cross section.
